(19) United States
(12) Patent Application Publication
(10) Pub. No.: US 2023/0415092 A1
(43) Pub. Date: Dec. 28, 2023

(54) METHODS AND SYSTEMS FOR CARBON CAPTURE

(71) Applicant: DAC City Inc., Santa Clara, CA (US)

(72) Inventors: James Finn ALDRIDGE, Santa Clara, CA (US); Arthur M. SHULENBERGER, Brisbane, CA (US); Robert D. CORMIA, La Honda, CA (US)

(21) Appl. No.: 18/323,620

(22) Filed: May 25, 2023

Related U.S. Application Data
(63) Continuation of application No. PCT/US2020/053196, filed on Sep. 29, 2020.
(60) Provisional application No. 62/908,280, filed on Sep. 30, 2019.

(51) Int. Cl. B01D 53/04; A01G 9/24

(52) U.S. Cl. CPC B01D 53/0454; B01D 53/0415; A01G 9/24; B01D 2257/504; B01D 2221/06

(57) ABSTRACT

The present disclosure provides processes and devices for adsorbing and concentrating carbon dioxide (CO₂) gas directly from ambient air. The methods may comprise extracting CO₂ directly from air and adding the extracted CO₂ to the air circulating inside an enclosed structure. A computer system coupled to chemical sensors and a process control software program may be operatively coupled to the devices and configured to optimize and control the operating conditions of the device, via machine learning algorithms, and additionally verify carbon dioxide adsorption and enrichment for encrypted transactional carbon credits.

### CROSS-REFERENCE

This application is a continuation of PCT Application No. PCT/US2020/53196, filed Sep. 29, 2020, which claims the benefit of U.S. Provisional Application No. 62/908,280, filed on Sep. 30, 2019, each of which applications is incorporated herein by reference in its entirety.

### BACKGROUND

There are various uses of carbon dioxide (CO₂). For example, plants use CO₂ during photosynthesis, in which atmospheric CO₂ may be incorporated into already existing organic carbon compounds, such as ribulose bisphosphate (RuBP), through the Calvin cycle. Apart from such uses, however, the presence of excess CO₂ may have negative consequences.

A significant environmental, economic, and humanitarian challenge facing the world today is global climate change (i.e., global warming). The predicted effects of global warming may include global increases in temperature and sea levels, shifts in weather patterns, and more extreme weather events. Global warming is generally believed to be caused by the accumulation of greenhouse gases in the atmosphere. It is evidenced that carbon dioxide (CO₂) accounts for the large majority of greenhouse gas emissions and is the primary driver of global climate change.

There are approaches that may be used for capturing CO₂ from the air. One approach of managing atmospheric emissions is through a process known as carbon scrubbing. Carbon scrubbing systems absorb waste CO₂, usually from industrial or power plants, and transport it to a storage site, where it will not enter the atmosphere. After it reacts with this compound, the captured CO₂ can later be stored or released and used for other purposes. Because of the increased focus on mitigating global climate change, a number of actors in the energy industry are developing and leveraging carbon scrubbing systems. However, such approaches can be expensive (e.g., high material costs or high energy requirements) and difficult to implement at a large scale.

### SUMMARY

The present disclosure provides methods, systems and devices for generating a stream of carbon dioxide (CO₂) which may be used, for example, in a closed structure. A method of the present disclosure may comprise capturing CO₂ directly from the air and directing the captured CO₂ gas to the air circulating inside the closed structure. In some cases, the closed structure may be a greenhouse and the methods and devices as provided herein may facilitate the generation of the CO₂ gas for enriching plant growth in the greenhouse.

Methods, systems and devices of the present disclosure may be used for carbon capture, such as capturing carbon monoxide (CO), CO₂ or both.

As provided herein, the devices of the present disclosure may be connected to the outside of the closed structure. The devices may be configured to receive atmospheric air, extract the CO₂ directly from the air, and add the extracted CO₂ to the air circulating inside the closed structure.

In some cases, the devices further comprise an operational control which may be managed by an embedded computer control system. The control system may be configured to measure in and out air flow rate, humidity, temperature, and/or gas levels (such as CO₂ levels). The control system may be further configured to accordingly adjust one or more device operating parameters, based at least in part on the measured data so as to maintain CO₂ level at a predetermined value in the closed structure and exhaust stream.

An aspect of the present disclosure provides a method for automatically maintaining a level of carbon dioxide (CO₂) in a closed structure, comprising: (a) inputting air into an adsorption unit, which air comprises oxygen (O₂), nitrogen (N₂) and CO₂; (b) using the adsorption unit to separate at least a portion of the CO₂ from the O₂ and N₂ to generate an effluent stream; and (c) directing the effluent stream to the closed structure, wherein the effluent stream has a flow rate or a CO₂ content that is selected to automatically maintain the level of CO₂ in the closed structure.

In some embodiments, the method further comprises using a CO₂ sensor to measure the level of CO₂ within the closed structure, and selecting the flow rate or the CO₂ content in the effluent stream based at least in part on the level of CO₂ measured within the closed structure. In some embodiments, the method further comprises using sensors to measure the temperature, pressure, or humidity of the input air, and using a controller to adjust the temperature, pressure or humidity of the input air. In some embodiments, the closed structure is a greenhouse.

Another aspect of the present disclosure provides a device for automatically maintaining a level of carbon dioxide (CO₂) in a closed structure, comprising: an adsorption unit containing an opening for an input stream of air, which air comprises oxygen (O₂), nitrogen (N₂) and CO₂, wherein the adsorption unit houses a sorbent cartridge that is configured to separate at least a portion of the CO₂ from the O₂ and N₂ to generate an effluent stream containing the at least the portion of the CO₂, wherein the sorbent cartridge is positioned to be exposed to the input stream of air during operation, wherein the adsorption unit contains a second opening for the effluent stream, which second opening is in fluid communication with the closed structure; and a controller operatively coupled to the adsorption unit, wherein the controller is configured to (i) control a flow rate of the input stream or the effluent stream, and (ii) automatically maintain the level of CO₂ in the closed structure.

In some embodiments, the device further comprises a CO₂ sensor configured to measure the level of CO₂ within the closed structure, wherein the controller is configured to select the flow rate or a content of the CO₂ content in the effluent stream based at least in part on the level of CO₂ measured by the CO₂ sensor within the closed structure. In some embodiments, the device further comprises a sensor configured to measure a temperature, pressure, or humidity of the input stream of air, wherein the controller is configured to adjust the temperature, pressure, or humidity of the input stream of air based at least in part on the temperature, pressure or humidity measured by the sensor. In some embodiments, the closed structure is a greenhouse.

Another aspect of the present disclosure provides a method for enriching a content of carbon dioxide (CO₂) in a closed structure, comprising: (a) inputting air into an adsorption unit comprising a reusable or removable sorbent cartridge, which air comprises oxygen (O₂), nitrogen (N₂) and CO₂; (b) using the reusable sorbent cartridge to separate at least a portion of the CO₂ from the O₂ and N₂ to generate an effluent stream; and (c) directing the effluent stream to the closed structure.

In some embodiments, the closed structure is a greenhouse. In some embodiments, the sorbent cartridge is reusable.

Another aspect of the present disclosure provides a device for enriching a content of carbon dioxide (CO₂) in a closed structure, comprising an adsorption unit comprising a reusable or removable sorbent cartridge, which reusable sorbent cartridge is configured to (i) take as input air comprising oxygen (O₂), nitrogen (N₂) and CO₂, and (ii) separate at least a portion of the CO₂ from the O₂ and N₂ to generate an effluent stream.

In some embodiments, the closed structure is a greenhouse. In some embodiments, the sorbent cartridge is reusable.

Another aspect of the present disclosure provides a method for generating a continuous stream of carbon dioxide (CO₂) in a closed structure, comprising: (a) inputting air into an adsorption unit comprising a first sorbent cartridge and a second sorbent cartridge, which air comprises oxygen (O₂), nitrogen (N₂) and CO₂; (b) using the first sorbent cartridge to separate at least a portion of the CO₂ from the O₂ and N₂; and (c) unloading CO₂ from the second sorbent cartridge to generate an effluent stream of CO₂ from the second sorbent cartridge into the closed structure.

In some embodiments, the first sorbent cartridge and the second sorbent cartridge are part of a rotatable member, which rotatable member rotates (i) from a first position in which one of the first sorbent cartridge and the second sorbent cartridge accepts air to (ii) a second position in which the one of the first sorbent cartridge and the second sorbent cartridge unloads CO₂ to yield the effluent stream. In some embodiments, the method further comprises exposing the first sorbent cartridge to an enriched stream of air from the closed structure and unloading CO₂ from the first sorbent cartridge to generate an effluent stream of CO₂ into the closed structure.

Another aspect of the present disclosure provides a device for generating a continuous stream of carbon dioxide (CO₂) in a closed structure, comprising: an adsorption unit containing an opening for the input of atmospheric air, which comprises oxygen (O₂), nitrogen (N₂) and CO₂; the adsorption unit containing at least two sorbent cartridges; at least one sorbent cartridge positioned to be exposed to an input stream of atmospheric air; and at least one sorbent cartridge positioned to be exposed to a stream of enriched air from the closed structure.

In some embodiments, the sorbent cartridges are positioned on a rotatable structure, the rotatable structure capable of moving each cartridge to be exposed to the input stream of atmospheric air and the input stream of enriched air from the closed structure.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1A illustrates a system including a closed structure with a couple of sample devices connected to the outside of the closed structure;

FIG. 1B illustrates a sample device as shown in FIG. 1A;

FIG. 2 shows the dimensions of a sample device of the present disclosure;

FIG. 3A shows a sample sorbent cartridge of the present disclosure;

FIG. 3B shows a sample cube as comprised in the sample sorbent cartridge of FIG. 3A;

FIG. 4 schematically illustrates a sample device of the present disclosure; and

FIG. 5 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least” or “greater than” applies to each one of the numerical values in that series of numerical values.

Whenever the term “no more than,” “less than,” or “less than or equal to” precedes the first numerical value in a series of two or more numerical values, the term “no more than” or “less than” applies to each one of the numerical values in that series of numerical values.

The term “about” or “nearly” as used herein generally refers to within (plus or minus) 15%, 10%, 9%, 8%, 7%, 6%, 5%, 4%, 3%, 2%, or 1% of a designated value.

As used herein, the singular forms “a”, “an”, and “the” include plural references unless the context clearly dictates otherwise.

In some embodiments, provided herein is a process for automatically maintaining a level of carbon dioxide (CO₂) in a closed structure. The process may first comprise inputting air into an adsorption unit. The air may be atmospheric air. The air may comprise oxygen (O₂), nitrogen (N₂) and CO₂. The air may include other material, such as carbon monoxide (CO) and water (H₂O). Next, the adsorption unit may be used to separate at least a portion of said CO₂ from the O₂and N₂ to generate an effluent stream. Subsequently, at least a portion of the generated effluent stream may be directed to the closed structure. In some cases, the effluent stream has a flow rate or a CO₂ content that is selected to automatically maintain the level of CO₂ in the closed structure.

In some cases, the adsorption unit may comprise a housing. The housing may comprise an opening. The opening may be configured to receive an input stream of atmospheric air.

The atmospheric air can be fed into the opening through a pipe. In some instances, a fan may be used to drive the atmospheric air through the pipe and into the housing. The fan may run at an appropriate rate. The rate may be fixed or vary depending upon, e.g., the applications for which the devices are used or the dimensions of the closed structure. The rate may be adjusted based upon CO₂ level contained in the air inside the closed structure.

In some cases, the rate may be greater than or equal to about 100 cubic feet per minute (cfm), 150 cfm, 200 cfm, 250 cfm, 300 cfm, 350 cfm, 400 cfm, 450 cfm, 500 cfm, 550 cfm, 600 cfm, 650 cfm, 700 cfm, 750 cfm, 800 cfm, 900 cfm, 1,000 cfm, or more. In some cases, the fan may run at a rate that is less than or equal to about 1,500 cfm, 1,400 cfm, 1,300 cfm, 1,200 cfm, 1,100 cfm, 1,000 cfm, 900 cfm, 800 cfm, 700 cfm, 600 cfm, 500 cfm, 400 cfm, 300 cfm, or less. In some cases, the fan may run at a rate that falls within any of the two values described above or elsewhere herein, for example, between about 400 cfm and about 800 cfm.

The adsorption unit may be a sorbent cartridge and comprise at least one sorbent disposed in the housing. The adsorption unit comprising the sorbent may be configured to facilitate a process for reversibly adsorbing CO₂. The process may comprise an adsorption process and a desorption process. During the adsorption process, the sorbent may be loaded with CO₂ while during the desorption process, CO₂ may be unloaded from the adsorbent and released into the air.

The adsorption and desorption processes may require precise control of pressure, temperature, and/or humidity in order to provide optimal reaction conditions.

To have a better control of these factors, in some cases, the absorption unit comprises a micro-computer with a process software program. Algorithms embedded in the process software may be configured to control the end-to-end process of the system. In some cases, the process software is in communication with at least one sensor. The at least one sensor can be a CO₂ sensor, configured to sense the CO₂ content inside the closed structure. In some instances, the process software is operably linked to a controller which controls the flow rate and can select a flow rate based on the CO₂ level measured in the closed structure. In some instances, the flow rate is selected to automatically maintain a level of CO₂ in the closed structure.

In some instances, the adsorption unit is also in communication with other types of sensors, which may include pressure sensors configured to sense the pressure of the inlet gas including the CO₂ partial pressure, temperature sensors configured to measure the temperature of the inlet gas, and sensors configured to sense the humidity of the inlet gas. The micro-computer can be in communication with a controller to adjust operating parameters such as fan speed/rate, temperature, pressure and/or humidity to provide optimal reactions conditions for direct air capture. These parameters can be adjusted based on inputs/readings from the sensors or based on inputs from a user. In some cases, the adsorption unit can run continuously and unmanned via the process software program.

The adsorption unit and associated systems may be optimized by use of an advanced machine learning process control algorithm. For example, an advanced machine learning process control may optimize air flow, gas distribution (i.e., distribution between the CO₂ application and a carbon sink), capture or release rate of a gas, or other operability parameters. In some instances, the process controller receives input from one or more sensors that measure parameters such as CO₂ in, CO₂ out, air temperature (e.g., temperature in, temperature out), air pressure, humidity, fan speed in, and/or fan speed out. Based on input data from the one or more sensors, a computer can generate a model of the CO₂ system (which can include air within the adsorption unit, environmental air, and air within the CO₂ application (i.e., the greenhouse)) and direct the process controller so as to optimize the function one or more of the components controlled by the process controller (e.g., fans, motors, sorbent cartridges, carbon sinks, or other components described herein) in order to achieve a desired result or meet a desired state (e.g., a temperature, a gas concentration, a pressure, a humidity, or any combination thereof). The process controller can optimize the state or function of one or more components within the adsorption unit so as to match the CO₂ system with a desired state or model of the CO₂ system. In some instances, the advanced machine learning process control allows the adsorption unit to run autonomously by measuring and adjusting for one or more continuously changing parameters (e.g., parameters measured by sensors and fed into the advanced machine learning process control system). In an example, the advanced machine learning process control can optimize CO₂ adsorption based on inlet conditions. In some instances, the advanced machine learning process control optimizes CO₂ adsorption for high-CO₂ inlet conditions. High-CO₂ conditions may be characterized as being greater than about 0.04%, about 0.05%, about 0.06%, about 0.07%, about 0.08%, about 0.09%, about 0.1%, about 0.2%, about 0.3%, about 0.4%, about 0.5%, about 1%, about 2%, about 3%, about 4%, about 5%, about 6%, about 7%, about 8%, about 9%, about 10%, about 11%, about 12%, or more by volume. In some instances, high-CO₂ conditions are characterized as being less than about 12%, about 11%, about 10%, about 9%, about 8%, about 7%, about 6%, about 5%, about 4%, about 3%, about 2%, about 1%, about 0.9%, about 0.8%, about 0.7%, about 0.6%, about 0.5%, about 0.4%, about 0.3%, about 0.2%, about 0.1%, about 0.09%, about 0.08%, about 0.07%, about 0.06%, about 0.05%, about 0.04%, or less. Examples of high-CO₂ inlet conditions include but are not limited to waste gas streams (e.g., flue gas or exhaust gas from power plants, refineries, manufacturing sites, incinerators or other combustion sources, chemical plants, or other commercial or industrial activities that generate CO₂), naturally occurring gas reserves, or other CO₂-enriched gas streams. In applications utilizing high-CO₂ inlet gas (e.g., from a waste gas stream), the adsorption units may be coupled to one or more carbon dioxide membrane separators. An advanced machine learning process control for use as described herein may optimize CO₂ adsorption for high-CO₂ inlet conditions wherein the system is coupled to a carbon dioxide membrane separator. The advanced machine learning process control may, for example, utilize a machine learning technique such as classification.

At least one sorbent may be used to separate at least a portion of the CO₂ from the atmospheric air. The sorbent may comprise a porous monolith structure which may be coated or treated with a liquid (such as a chemical or chemical solution) that may reversibly bind to CO₂. The use of the porous monolith may result in a lower pressure drop, thereby providing for more efficient heat transfer.

In some instances, the sorbent comprises an alkali metal or earth alkaline metal adsorbent. As an example, the sorbent comprises an alkali carbonate wash-coat on a highly porous ceramic honeycomb monolith (HCML). These sorbent materials may allow for a preferred balance of chemisorption and physisorption, relatively high loading capacity and fast throughput. In some instances, through temperature changes, the CO₂ can later be desorbed, to form an effluent stream of CO₂ gas that can be cooled and fed into the closed structure. In another example, the sorbent comprises an activated charcoal honeycomb monolith rinsed with a potassium carbonate coating, or chemically treated, using a wet or dry chemistry, such as ammonia gas plasma. The porous carbon material may also be treated to enhance pore volume geometry for efficient carbon dioxide adsorption and desorption.

In some instances, the housing contains a second opening for an outgoing stream of stripped atmospheric air. Once the CO₂ has been separated from the atmospheric air by the sorbent, the stripped atmospheric air may exit the device through the second opening and be fed back into the atmosphere. In some instances, the stripped atmospheric air can be fed back into the atmosphere through a pipe.

A fan can be used to drive the CO₂ stripped atmospheric air back into the atmosphere through the pipe. The fan may run at a predetermined rate. The rate may be fixed or vary depending upon, e.g., the applications or the dimensions of the closed structure. The rate may be adjusted based upon CO₂ level contained in the air inside the closed structure. In some cases, the rate may be greater than or equal to about 100 cubic feet per minute (cfm), 150 cfm, 200 cfm, 250 cfm, 300 cfm, 350 cfm, 400 cfm, 450 cfm, 500 cfm, 550 cfm, 600 cfm, 650 cfm, 700 cfm, 750 cfm, 800 cfm, 900 cfm, 1,000 cfm, or more. In some cases, the fan may run at a rate that is less than or equal to about 1,500 cfm, 1,400 cfm, 1,300 cfm, 1,200 cfm, 1,100 cfm, 1,000 cfm, 900 cfm, 800 cfm, 700 cfm, 600 cfm, 500 cfm, 400 cfm, 300 cfm, or less. In some cases, the fan may run at a rate that falls within any of the two values described above or elsewhere herein, for example, between about 400 cfm and about 800 cfm.

In some cases, the adsorption unit may comprise one or more additional openings. The openings may be used for directing at least a portion of the effluent stream to the closed structure. The effluent stream may be fed into the closed structure through a pipe. In some instances a fan can be used to drive the effluent stream of CO₂ through the pipe and into the structure.

In some cases, the one or more additional openings comprise one or more inlets. The inlets may be configured to receive additional gas streams other than the atmospheric air. For example, the inlets may be configured to receive a gas stream from the closed structure. The gas stream may have a temperature that is higher than that of the sorbent loaded with CO₂. Once the gas stream is directed into the adsorption unit, the sorbent may be exposed to and put into contact with the gas stream. Such contact may cause the CO₂ to be unloaded from the sorbent to the gas stream, thereby generating an effluent stream which has an increased CO₂ level relative to the gas stream. The generated effluent stream may then be directed back to the closed structure for use. Adsorption and unloading of CO₂ from the sorbent may employ a moisture swing cycle. In some instances, the moisture swing cycle utilizes a temperature and humidity gradient to control adsorption/unloading of CO₂ from the sorbent. The inlet temperature may be ambient air temperature. In some instances, the inlet air temperature is between about 10 and about 40 degrees Celsius during the loading phase of the moisture swing. By way of non-limiting example, the inlet air temperature may be at least about 16, about 17, about 18, about 19, about 20, about 21, about 22, about 23, about 24, about 25, about 26, about 27, about 28, about 29, about 30 degrees Celsius, or more during the loading phase of the moisture swing. Inlet air temperature may be less than about 30, about 29, about 28, about 27, about 26, about 25, about 24, about 23, about 22, about 21, about 20, about 19, about 18, about 17, about 16 degrees Celsius, or less during the loading phase of the moisture swing. In some instances, the inlet temperature is about 19 degrees Celsius during the loading phase of the moisture swing. During the exhaust phase (or unloading phase) of the moisture swing, the temperature may increase to between about 40 and about 70. By way of non-limiting example, the temperature during the unloading phase may be at least about 50, about 51, about 52, about 53, about 54, about 55, about 56, about 57, about 58, about 59, about 60 degrees Celsius, or more. In other examples, the temperature during the unloading phase may be less than about 65, about 64, about 63, about 62, about 61, about 60, about 59, about 58, about 57, about 56, about 55, about 54, about 53, about 52, about 51, about 50 degrees Celsius, or less. In other instances, the temperature during the unloading phase of the moisture swing is about 55 degrees Celsius. The temperature gradient may, for example, be matched to the exothermic and endothermic heat of reaction (e.g., of the sorbent with CO₂ (or its various hydrated or protonated states, e.g., CO₃²⁻, HCO₃⁻, H₂CO₃)).

During the moisture swing cycle, humidity may also be adjusted to optimize loading or unloading. For example, humidity may be adjusted from a minimum of about 15% to a maximum of about 85% to optimize loading and unloading of CO₂. Temperature and humidity gradients may be controlled or optimized by use of an advanced machine learning process control system. The process control system may ensure that temperature, humidity, and flow rate are precisely controlled during loading and unloading to maximize the throughput and efficiency of carbon dioxide capture and enrichment. The efficiency of carbon capture may be at least about 10%, about 20%, about 30%, about 40%, about 50%, about 60%, about 70%, about 80%, about 85%, about 90%, about 95%, about 96%, about 97%, about 98% or more. The efficiency of carbon capture may be less than about 99%, about 98%, about 97%, about 96%, about 95%, about 90%, about 80%, about 70%, about 60%, about 50%, about 40%, about 30%, about 20%, or less. In some instances, the efficiency of carbon capture may be about 90%. Efficiency of carbon capture may as used herein may refer to a reaction yield for chemisorption, physisorption, or inlet/outlet change in partial pressure.

The process control system may control parameters within the adsorption unit (e.g., temperature, moisture, fan speed, gas distribution, sorbent cartridge temperature, sorbent cartridge moisture, and the like) to maintain a predetermined efficiency of CO₂ capture and/or enrichment. For example, temperature and moisture may be measured (e.g., via temperature and moisture sensors disposed within the adsorption unit, in the inlet air stream, in the effluent air stream, in the external environment, within the enclosure, or any combination thereof) and adjusted for by an advanced machine learning process control system. Such a process control system may modulate the fan speed, gas distribution (e.g., to a carbon sink, to the environment, or to an enclosure), or temperature and moisture controllers within the adsorption unit to ensure throughput and efficiency of CO₂ capture and enrichment. The levels of unloading (and associated CO₂ enrichment profiles) may be coupled to the enrichment profile specified by the CO₂ application (e.g., a preferred CO₂ enrichment profile for an enclosure such as a greenhouse). The enrichment profile may be optimized based on, for example, the preferences of the plants located in an enclosure and in gas communication with the absorption unit.

Another aspect of the present disclosure provides processes and devices for enriching the content of carbon dioxide (CO₂) in a closed structure utilizing a removable or reusable sorbent cartridge. A sample process may comprise directing air into an adsorption unit. The adsorption unit may comprise a sorbent cartridge. The sorbent cartridge may be reusable or removable. The air may comprise oxygen (O₂), nitrogen (N₂) and CO₂.

The process may further comprise using the sorbent cartridge to separate at least a portion of the CO₂ from the O₂ and N₂ to generate an effluent stream. The effluent stream may comprise CO₂ at a level that is greater than that of the air. The effluent stream may be directed into the closed structure once generated. The adsorption unit may comprise at least one sorbent disposed in a housing.

As described above or elsewhere herein, the adsorption unit may comprise one or more pipes and/or fans for moving air into the unit over the sorbent cartridge housed in the unit in order to capture CO₂ and then unloading the captured CO₂ to generate an effluent stream, at least a portion of which may be directed into a closed structure. The adsorption unit may be oriented and implemented in a modular fashion to enable use on a broad range of scalability. Fans may also scale with necessary air flow or power demand, for example, to enable use in domestic, commercial, or industrial settings. Modular implementation of the adsorption units described herein may be optimized based on demands such as air flow, air volume, or air quality (e.g., temperature, density, humidity, gas concentration, and the like). The adsorption units may also be optimized based on electricity (e.g., cost, availability, current-carrying capacity, power demand), or gas parameters (e.g., demand, capacity, availability) wherein the gas may be any separable gas (e.g., CO₂, N₂, O₂). Adsorption units and fans can be implemented modularly such that even the largest machines can be operated with commercial electricity (e.g., 110 V, 120 V, 220 V, 230 V, 240 V, 480 V, and the like). CO₂ capacity or availability may be modulated by coupling one or more adsorption units to a sink. A sink may be any implement useful for the capture and/or sequestration of carbon (i.e., a carbon sink). By way of non-limiting example, a sink may be a chemical solution such as an amine solvent (e.g., diethanolamine (DEA), monoethanolamine (MEA), methyldiethanolamine (MDEA), diisopropanolamine (DIPA), aminoethoxyethanol (diglycolamine, DGA), or the like). A sink may comprise activated carbon, silica gel, alumina, resin, zeolite, or other adsorbent materials including any of those described herein. A sink may be implemented in order to draw CO₂ off an adsorption unit and into the CO₂ application (e.g., a greenhouse or carbon storage utility).

As provided herein, the sorbent may comprise a porous monolith structure. The monolith structure may be coated with a coating that may reversibly bind to CO₂. The coating may be a chemical. The coating may comprise an alkali or earth alkaline metal adsorbent. The coating may comprise organic or inorganic compounds. The coating may comprise amino silane, which may or may not be branched. The coating may be deposited on a surface of the monolithic structure. The deposition may be conducted using gas treatment, which can be applied to ceramic, carbon and/or polymer/resin systems. The coating may be deposited in such a way that substantially enhances the CO₂ adsorption.

For example, the abundance and functionality of nitrogen (i.e., primary, secondary, and tertiary amines), the crosslinking of silica, and the ability to blend pretreatment of the substrate, as a primer, may enhance bonding of the hyperbranched amino silane. Additionally, incorporating a “mobile phase” of polyamine may further enhance CO₂ sorption and desorption. The plasma treatment and deposited fixed and mobile coatings can be synergistic with the porosity of the (ceramic, carbon, or resin/polymer) substrate, providing an extensible process to enhance gas sorption on a variety of materials, with applications beyond CO₂ adsorption.

The coating along with the monolith structure may facilitate the adsorption and desorption of CO₂. As provided above or elsewhere herein, the adsorption and desorption of CO₂ in the adsorption unit may generate an effluent stream with a certain concentration (or level) of CO₂. Depending upon specific applications (e.g., the use of the CO₂), the adsorption and desorption processes or the operating parameters of the adsorption unit may be adjusted to maintain the CO₂ at a predetermined level. One or more sensors may be used to measure the CO₂ level inside the adsorption unit or outside of the adsorption unit (e.g., in the closed structure to which the device including the adsorption unit is connected). In some cases, the one or more sensors may be used to measure the CO₂ level in one or more gas streams, which includes, e.g., the input air stream, the generated effluent stream, the gas stream received from the inside of the closed structure or the combinations thereof.

In some cases, when the CO₂ level deviates from (greater than or lower than) the predetermined level, the coating and/or the monolithic structure may be removed and a new coating and/or a monolithic structure may be used to continue the process. In some cases, the coating may not be removed, and a new coating may be applied to a surface of the monolithic structure before the subsequent processes are conducted.

In some cases, the absorption unit comprises a micro-computer with a process software program. Algorithms embedded in the process software may control the end-to-end process of the system. As described elsewhere herein, the process software may be configured to control some or all of sensors (including pressure sensors, humidity sensors, temperature sensors etc.), air flow rate, temperature, and/or fan speed in order to optimize the direct air capture reaction (i.e., receiving atmospheric air and capturing CO₂ directly from the received air). In some cases, the algorithms embedded in the software program monitor the throughput and efficiency of the sorbent cartridges.

Also provided herein are processes and devices for generating a continuous stream of carbon dioxide (CO₂) in a closed structure. The devices may be configured to facilitate the processes which comprise receiving air and inputting the air into an adsorption unit of the devices of the present disclosure. The air may comprise oxygen (O₂), nitrogen (N₂) and CO₂. The adsorption unit may comprise one or more sorbent cartridges. The one or more sorbent cartridges may be the same or different. In cases where the cartridges differ from one another, they may differ in the shape, dimension, composition, or combinations thereof. In some cases, the adsorption unit comprises a first sorbent cartridge and a second sorbent cartridge.

Next, the first sorbent cartridge may be used to separate at least a portion of the CO₂ from the O₂ and N₂ comprised in the air. The first sorbent cartridge may comprise sorbent that captures the CO₂ while the cartridge is exposed to the air. Once the air is in contact with the sorbent, the sorbent may be loaded with CO₂. Subsequently, at least a portion of the loaded CO₂ may be unloaded to generate an effluent stream which comprises CO₂. In some cases, the CO₂ may be unloaded from the second sorbent cartridge which generates an effluent stream comprising CO₂. At least a portion of the effluent stream may be directed into the closed structure for reuse. As described elsewhere herein, the sorbent cartridges may be removed and replaced after several uses. Alternatively, the sorbent cartridges may be reusable.

In one specific embodiment, the adsorption unit comprises at least two sorbent cartridges. The process comprises using a first of the sorbent cartridges to separate CO₂ from the input air and a second of the cartridges to unload CO₂ to generate an effluent stream into the closed structure. In some instances, the first sorbent cartridge and second sorbent cartridge unload and adsorb CO₂ at the same time in order to provide for a continuous input and output of CO₂.

In some cases, the adsorption unit comprises multiple sorbent cartridges. Once the air is received, half of the cartridges may be loaded with CO₂ once being put into contact with the air. The other half of the cartridges may contact a second gas stream which has a higher temperature than the air, which may facilitate the uploading of the CO₂ from the cartridges, thereby generating an effluent stream comprising CO₂.

In some instances, the adsorption unit comprises a housing which contains a rotatable member. The one or more sorbent cartridges may be connected, either directly or indirectly, to the rotatable member. A portion (e.g., half) of the sorbent cartridges may be disposed in the path of a first gas stream (e.g., the input stream of air) and an additional portion of the sorbent cartridges may be disposed in the path of a second gas stream (e.g., an inside air from the closed structure). The first gas stream may have a temperature different from that of the second gas stream. In some cases, the first gas stream has a lower temperature than the second has stream. The sorbent cartridges exposed to the first gas stream may load the sorbent comprised therein with CO₂, and the sorbent cartridges in contact with the second gas stream may unload the CO₂ from the sorbent to the second gas stream. The loading and unloading may be conducted sequentially, or simultaneously. In some cases, simultaneous loading and unloading process enables the production a continuous stream of CO₂ enriched air.

The rotatable member may be configured to rotate the sorbent cartridges after each of such cycle (i.e., loading and unloading). After the rotation, the sorbent cartridges exposed to the first gas stream may be subject to contact with the second gas stream and the sorbent cartridges exposed to the second gas stream may be subject to contact with the first gas stream. The rotatable member may be operatively connected with the micro-computer with a process software program. Algorithms in the software may control the rotate time, frequency, duration, depending upon e.g., CO₂ level measured by the sensors.

### Computer Systems

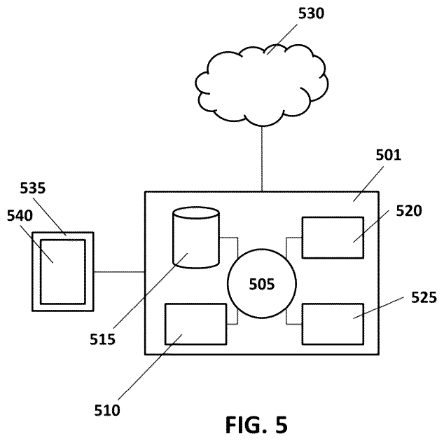

The present disclosure provides computer systems that are programmed to implement methods of the disclosure. FIG. 5 shows a computer system 501 that is programmed or otherwise configured to perform the processes of the present disclosure. The computer system 501 can regulate various aspects of processes of the present disclosure, such as, for example, control and adjust the rotate speed, duration and/or frequency, fan speed, air flow rate, and temperatures of gas streams. The computer system 501 can be an electronic device of a user or a computer system that is remotely located with respect to the electronic device. The electronic device can be a mobile electronic device.

The computer system 501 includes a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet.

The computer system 501 can communicate with one or more remote computer systems through the network 530. For instance, the computer system 501 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine-readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535 that comprises a user interface (UI) 540 for providing, for example, local machine parameters and setting, store data in the cloud, set CO₂ level and airflow, data collected by the sensors such as CO₂ level in the effluent stream, temperatures of the inputted air, effluent stream or any other gas streams in and out of the machine, and/or air flow rate etc. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 505. The algorithm can, for example, control the end-to-end process of the Direct Air Capture (DAC) system ensuring that the sorbent operating conditions are matched to the pressure, temperature, and humidity of inlet gas, and that cartridges are monitored for efficiency and throughput throughout their lifetime.

### EXAMPLES

### Example 1—Device

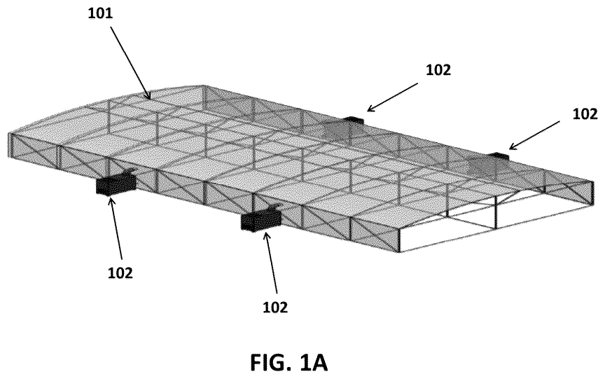

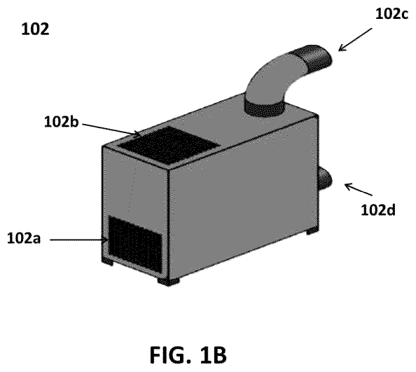

FIG. 1A illustrates a sample system wherein multiple devices of the present disclosure 102 are connected with a closed structure 101. The closed structure may be a greenhouse. The devices 102 may generate CO₂ gas for enriching plant growth in the greenhouse. The device may extract CO₂ directly from the air using an air capture chemistry along with a mechanically engineered system. The device may work by plugging into the outside of the closed structure, then captures the CO₂ from the outside air and adds the captured CO₂ to the air circulating inside the closed structure. As the CO₂ increases, the device controls the amount of CO₂ flowing into the closed structure.

A sample device 102 is shown in FIG. 1B. The device may comprise an inlet 102a for receiving the environmental air and an outlet 102b for directing the air out of the device. Additionally, the device may further comprise an additional inlet 102d which is configured to receive an air inside the closed structure (e.g., greenhouse) and an additional outlet 102c which directs the air out of the device.

Operational control may be managed by an embedded computer control system which measures parameters including in and out air flows, CO₂ levels, temperature levels etc. In some cases, the device is configured to run continuously unattended. Communication to the device may be via a Wi-Fi interface which allows a network connection to multiple devices. The device may be monitored and controlled using mobile app from which the user can view a variety of information regarding the device and/or processes. For example, a user may view local machine parameters and settings, store data in the cloud, set CO₂ level and airflow, fan speed, rotation rate, speed of the rotatable member, and/or data measured and collected by the sensors.

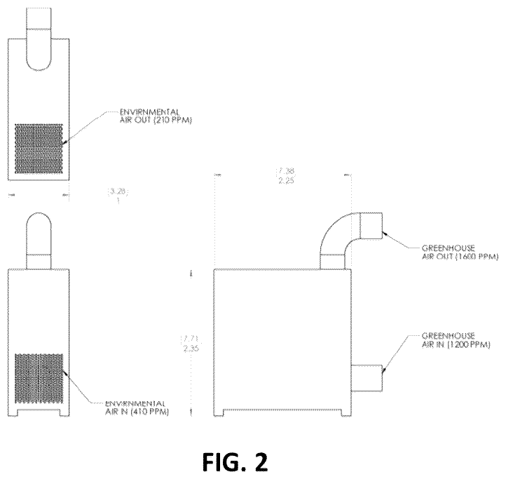

Dimensions of a sample device are shown in FIG. 2. As will be appreciated, depending upon specific applications or dimensions of the closed structure to which the device is to be connected, dimensions of the sample device may vary.

### Example 2—Sorbent Systems

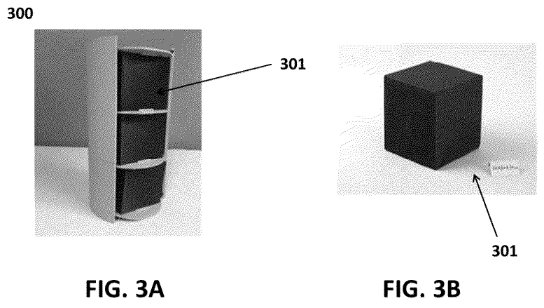

FIG. 3A shows a sample sorbent cartridge 300 of the present disclosure. The sorbent cartridge may be made up of three 4-inch square cubes (301 in FIG. 3B). However, the cubes may be made longer or round to scale up amount of CO₂ to capture. The sorbent cartridge may comprise any number of the cubes (e.g., greater than or equal to about 1, 2, 3, 4, 5, 6, 7, 8, 9, 10, 11, 12, 13, 14, 15 or more). In some cases, instead of multiple cubes, the sorbent cartridge comprises one long cube.

### Example 3—Mechanical Device

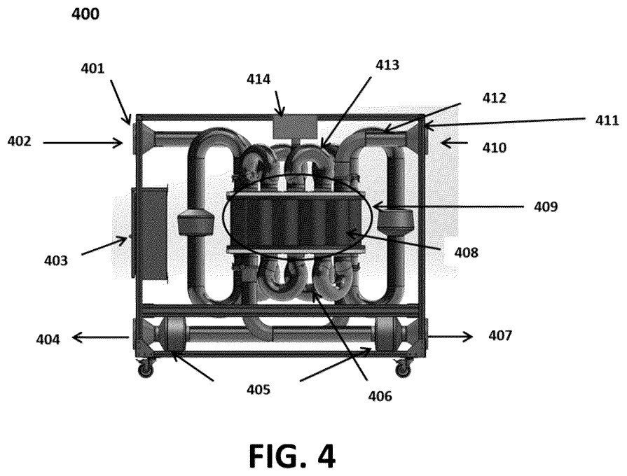

As illustrated in FIG. 4, the device of the present disclosure may be a mechanical motorize device 400. The device may be used for moving large volumes of air over the sorbent cartridges 408 to capture CO₂, then gas off the CO₂. Two steams of air may pass over the sorbent cartridges, the outside air 402 and the enriched inside air 410. The device may rotate the sandwich 409 to expose the sorbent cartridges to inputted outside air 402 or enriched inside air 410. The device may work by exposing part of the cartridges to the cool outside air stream, thus loading the sorbent with CO₂, and at the same time exposing the other cartridges with heated inside enriched air and thus unloading the CO₂ from the sorbent to the enriched air. In this way the device can provide a continuous stream of CO₂ enriched air. A complex algorithm in the computer software may be used to control rotate time, fan speed, heat added based on sensor inputs and instructions from the user.

The sorbent cartridges may be removable. The sandwich can be mounted in a vertical or horizontal configuration. The motor 414 may drive and rotate either the gas manifold (e.g., the top gas manifold 413 or the bottom gas manifold 406) or the sandwich. Heat may be added to incoming enriched air. Heat may be added using an air heater 412. Moisture may also be added to the enriched side of device.

Example operations of the device may include the steps: (a) fan(s) 401 driving the outside air in to the sorbent cartridges and the same air out 404, which process may load half of the sorbent cartridges with CO₂, (b) fan(s) 411 driving the inside enriched air into the sorbent cartridges and the same air out 407, which process may unload half of the sorbent cartridges with CO₂, and (c) a motor rotating the sandwich or manifold.

A computer system 403 embedded in the device may be configured to control all functions automatically. The device may be monitored and operated remotely through a Wi-Fi/TCP/IP connection. As provided herein, the device can be scaled to a larger size by changing any component comprised therein.

Air flow rate of the air in and out of the device may be monitored and adjusted. The air flow rate may be monitored and adjusted by the computer system. The air flow rate may be within a certain range based on specific application for which the device is used. In some cases, the air flow rate may be greater than or equal to about 50 cfm, 70 cfm, 90 cfm, 100 cfm, 125 cfm, 150 cfm, 175 cfm, 200 cfm, 220 cfm, 240 cfm, 260 cfm, 280 cfm, 300 cfm, 320 cfm, 340 cfm, 360 cfm, 380 cfm, 400 cfm, 425 cfm, 450 cfm, 475 cfm, 500 cfm, or more. In some cases, the air flow rate may be less than or equal to about 700 cfm, 650 cfm, 600 cfm, 550 cfm, 500 cfm, 450 cfm, 400 cfm, 375 cfm, 350 cfm, 325 cfm, 300 cfm, 275 cfm, 250 cfm, 225 cfm, 200 cfm, 175 cfm, 150 cfm, 125 cfm, 100 cfm, or less. In some cases, the air flow rate may be between any of the two values described above or elsewhere herein, for example, between about 250 cfm and about 350 cfm. In some cases, the air flow rate of the inputted air is greater than that of the outputted air.

The CO₂ level in the air stream in and out of the device may be monitored and adjusted. The CO₂ level may be monitored and adjusted by the computer system. The CO₂ level may be measured by one or more sensors. The measured CO₂ level may be compared to a predetermined CO₂ level. The CO₂ level may be adjusted when the measured level deviates from the predetermined level. The adjustment may be achieved by changing the operating parameters of the device. For example, the CO₂ level may be adjusted by altering the air flow rate of the air in or out of the device, fan speed, rotation rate, duration and frequency, temperature, humidity etc. In some cases, the outside air has a CO₂ level that is between about 100 parts per million (ppm) and about 500 ppm. As to the inside air, the air may have a CO₂ level that is between about 200 ppm and about 2,500 ppm. The inputted outside air may have a CO₂ level that is greater than that of the outputted outside air due to the adsorption of CO₂. The inputted inside air may have a CO₂ level that is less than that of the outputted inside air due to desorption of the CO₂ from the sorbent.

### Example 4—Microcomputer Software Control

Devices of the present disclosure may comprise a micro-computer with a process software program. Algorithms embedded in the software may control the end-to-end process of the device ensuring that the sorbent operating conditions are matched to the pressure, temperature, and humidity of inlet gas, and that cartridges are monitored for efficiency and throughput throughout their lifetime. Gas sorption and desorption generally require precise control and/or monitoring of inlet pressure, carbon dioxide partial pressure, temperature, and humidity, ensuring optimal synergy with the surface chemistry of the sorbent, morphology of the substrate, and the desired throughput of the device. Process control may include control of sensors, analytics, and control of temperature, pressure, and humidity of inlet gas.

Artificial intelligence, such as a machine learning algorithm, may be used to discover, optimize, and control the operating conditions for each sorbent chemistry and substrate morphology in real-time, and be embedded into each device. The machine learning algorithm can receive as input a plurality of current operating parameters of the sorbent and a plurality of environmental parameters. The machine learning algorithm can process the plurality of operating parameters and the plurality of environmental parameters to generate control signals for controlling the sorbent. Applying the control signals to the sorbent may change the operating parameters of the sorbent, and consequently, the level of CO₂ in the output stream. In this way, the machine learning algorithm can maintain the level of CO₂ in the output stream at a desired level.

The plurality of operating parameters may include an input fan speed, an output fan speed, and a temperature, a pressure, and a humidity in the sorbent. The operating parameters of the sorbent may be controllable by tuning control signals associated with the operating parameters. For example, one control signal may be associated with the output fan of the sorbent, and the speed of the output fan can be controlled by adjusting such control signal (e.g., by varying the current or voltage of the control signal). The plurality of environmental parameters may include the level of CO₂ in the input stream, the level of CO₂ in the output stream, and the temperature and humidity of the input and output streams.

The machine learning algorithm may be a supervised machine learning algorithm. That is, the machine learning algorithm may be trained on a plurality of labeled training examples. A particular labeled training example may include, for a given time or time period, (1) values of the operating parameters of the sorbent and values the of environmental parameters, and (2) the corresponding level of CO₂ in the output stream at the given time or time period. Training the machine learning algorithm may involve providing the values of the operating parameters and environmental parameters to an untrained version of the machine learning algorithm to generate a predicted level of CO₂ in the output stream, comparing the predicted level to the actual level of CO₂ recorded for the given time or time period, and updating the internal parameters (e.g., weights and biases) of the machine learning algorithm to account for the difference between the predicted level and actual level. Repeating this process many times for many training examples may result in a trained machine learning algorithm that is capable of predicting levels of CO₂ in the output stream.

If the predicted (or actual) level of CO₂ in the output stream deviates from the desired level, the control signals of the sorbent can be adjusted in real time. In some instances, a separate machine learning algorithm can be used to determine the adjustments to the control signals. Such a machine learning algorithm can take as input (i) the deviation of the predicted or actual CO₂ level from the desired CO₂ level and (ii) any known environmental parameters, and output control signals that result in the CO₂ in the output stream returning to the desired level. Such a machine learning algorithm can be trained in a similar manner as described above.

In other instances, a single end-to-end machine learning algorithm may be trained to both predict future CO₂ levels and generate control signals to adjust those CO₂ levels appropriately. Such an end-to-end machine learning algorithm may be, for example, a reinforcement learning algorithm that learns control signals that results in the desired CO₂ levels through a trial-and-error process. In additional instances, the level of CO₂ may be measured (e.g., via a CO₂ sensor) within the CO₂ application (e.g., greenhouse), and used as an input parameter. In such an instance, the machine learning algorithm may modulate the function of the adsorption unit in order to achieve a desired CO₂ level within the CO₂ application. The machine learning algorithm may further employ a model of CO₂ levels within the CO₂ application and optimize function of the adsorption unit by comparing measured values with desired values and adjusting accordingly to fit the prescribed model.

The machine learning algorithm may be a neural network. Neural networks can employ multiple layers of operations to predict one or more outputs. Neural networks can include one or more hidden layers situated between an input layer and an output layer. The output of each layer can be used as input to another layer, e.g., the next hidden layer or the output layer. Each layer of a neural network can specify one or more transformation operations to be performed on input to the layer. Such transformation operations may be referred to as neurons. The output of a particular neuron can be a weighted sum of the inputs to the neuron, adjusted with a bias and multiplied by an activation function, e.g., a rectified linear unit (ReLU) or a sigmoid function.

Training a neural network can involve providing inputs to the untrained neural network to generate predicted outputs, comparing the predicted outputs to expected outputs, and updating the algorithm's weights and biases to account for the difference between the predicted outputs and the expected outputs. Specifically, a cost function can be used to calculate a difference between the predicted outputs and the expected outputs. By computing the derivative of the cost function with respect to the weights and biases of the network, the weights and biases can be iteratively adjusted over multiple cycles to minimize the cost function. Training may be complete when the predicted outputs satisfy a convergence condition, e.g., a small magnitude of calculated cost as determined by the cost function.

The process algorithm and sorption/desorption control tool may be extensible to other sorbent systems and devices, ensuring performance and reliability for every application. The device may run continuously and unmanned via the process software program.

Blockchain software may add the ability to implement verification and traceability to the data. The process control may be integrated with a crypto-payment system for verified carbon dioxide reduction trading and payment in evolving carbon market systems. When carbon dioxide is removed from an environment, the amount of such carbon dioxide can be determined, and a transaction comprising the amount can be posed to a blockchain. The transaction may be digitally signed by a trusted third-party that has verified that the amount listed in the transaction is correct. In some cases, the trusted third-party may measure the amount directly using a secure measurement device. In other cases, the trusted third-party may conduct periodic audits of the transactions. In still other cases, the blockchain may utilize a distributed ledger to ensure veracity of the data posted therein. Once posted to the blockchain, the transactions may be immutable. This additionally may provide assured (validated) Carbon Dioxide Removal metrics for carbon pricing, verified offsets, or meeting carbon neutral targets. Traceability is also extended to managing the plants or items in the growing area that have barcodes or IDs. A plant can be traced and verified using the data locked in a blockchain. While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for automatically maintaining a level of carbon dioxide (CO₂) in a closed structure, comprising:
(a) inputting air into an adsorption unit, which air comprises oxygen (O₂), nitrogen (N₂) and carbon dioxide (CO₂);
(b) using said adsorption unit to separate at least a portion of said CO₂ from said O₂ and N₂ to generate an effluent stream; and
(c) directing said effluent stream to said closed structure, wherein said effluent stream has a flow rate or a CO₂ content that is selected to automatically maintain said level of CO₂ in said closed structure.

2. The method of claim 1, further comprising using a CO₂ sensor to measure said level of CO₂ within said closed structure, and selecting said flow rate or said CO₂ content in said effluent stream based at least in part on said level of CO₂ measured within said closed structure.

3. The method of claim 1, further comprising using sensors to measure the temperature, pressure, or humidity of said input air, and using a controller to adjust the temperature, pressure or humidity of said input air.

4. The method of claim 1, wherein said closed structure is a greenhouse.

5. The method of claim 1, wherein (b) comprises:
(i) obtaining a plurality of operating parameters of said adsorption unit and a plurality of environmental parameters;
(ii) processing said plurality of operating parameters and said plurality of environmental parameters with a machine learning algorithm to generate control signals for said adsorption unit, wherein said control signals are configured to control said adsorption unit so as to maintain said level of CO₂ in said closed structure; and
(iii) applying said control signals to said adsorption unit to maintain said level of CO₂ in said closed structure.

6. The method of claim 5, wherein (i) to (iii) are performed in real time.

7. The method of claim 5, wherein said machine learning algorithm is a supervised machine learning algorithm or a reinforcement learning algorithm.

8. The method of claim 5, wherein said plurality of operating parameters comprises one or more of an input fan speed, an output fan speed, and a temperature, a pressure, and a humidity of said adsorption unit.

9. The method of claim 5, wherein said plurality of environmental parameters comprises one or more of a level of CO₂ in said air, a level of CO₂ in said effluent stream, an external temperature, and an external humidity.

10. The method of claim 1, further comprising determining a quantity of CO₂ separated by said adsorption unit and posting a transaction to a blockchain comprising said quantity.

11. The method of claim 10, wherein said transaction comprises an identifier associated with said adsorption unit.

12. The method of claim 10, wherein said transaction posted to said blockchain is digitally signed by a trusted third-party.

13. The method of claim 10, wherein said blockchain comprises an emission training system.

14. A device for automatically maintaining a level of carbon dioxide (CO₂) in a closed structure, comprising:
an adsorption unit containing an opening for an input stream of air, which air comprises oxygen (O₂), nitrogen (N₂) and CO₂, wherein said adsorption unit houses a sorbent cartridge that is configured to separate at least a portion of said CO₂ from said O₂ and N₂ to generate an effluent stream containing said at least said portion of said CO₂, wherein said sorbent cartridge is positioned to be exposed to the input stream of air during operation, wherein said adsorption unit contains a second opening for said effluent stream, which second opening is in fluid communication with said closed structure; and
a controller operatively coupled to said adsorption unit, wherein said controller is configured to (i) control a flow rate of said input stream or said effluent stream, and (ii) automatically maintain said level of CO₂ in said closed structure.

15. The device of claim 14, further comprising a CO₂ sensor configured to measure said level of CO₂ within said closed structure, wherein said controller is configured to select said flow rate or a content of said CO₂ content in said effluent stream based at least in part on said level of CO₂ measured by said CO₂ sensor within said closed structure.

16. The device of claim 14, further comprising a sensor configured to measure a temperature, pressure, or humidity of said input stream of air, wherein said controller is configured to adjust said temperature, pressure, or humidity of said input stream of air based at least in part on said temperature, pressure or humidity measured by said sensor.

17. The device of claim 14 wherein said closed structure is a greenhouse.

18. A method for enriching a content of carbon dioxide (CO₂) in a closed structure, comprising:
(a) inputting air into an adsorption unit comprising a removable sorbent cartridge, which air comprises oxygen (O₂), nitrogen (N₂) and carbon dioxide (CO₂);
(b) using said removable sorbent cartridge to separate at least a portion of said CO₂ from said O₂ and N₂ to generate an effluent stream; and
(c) directing said effluent stream to said closed structure.

19. The method of claim 18, wherein said closed structure is a greenhouse.

20. The method of claim 18, wherein said sorbent cartridge is reusable.

21. A device for enriching a content of carbon dioxide (CO₂) in a closed structure, comprising an adsorption unit comprising a removable sorbent cartridge, which reusable sorbent cartridge is configured to (i) take as input air comprising oxygen (O₂), nitrogen (N₂) and CO₂, and (ii) separate at least a portion of said CO₂ from said O₂ and N₂ to generate an effluent stream.

22. The device of claim 21, wherein said closed structure is a greenhouse.

23. The device of claim 21, wherein said sorbent cartridge is reusable.

24. A method for generating a continuous stream of carbon dioxide (CO₂) in a closed structure, comprising:
(a) inputting air into an adsorption unit comprising a first sorbent cartridge and a second sorbent cartridge, which air comprises oxygen (O₂), nitrogen (N₂) and carbon dioxide (CO₂);
(b) using said first sorbent cartridge to separate at least a portion of said CO₂ from said O₂ and N₂; and
(c) unloading CO₂ from said second sorbent cartridge to generate an effluent stream of CO₂ from said second sorbent cartridge into said closed structure.

25. The method of claim 24, wherein said first sorbent cartridge and said second sorbent cartridge are part of a rotatable member, which rotatable member is configured to rotate (i) from a first position in which one of said first sorbent cartridge and said second sorbent cartridge accepts air to (ii) a second position in which said one of said first sorbent cartridge and said second sorbent cartridge unloads CO₂ to yield said effluent stream.

26. The method of claim 24, further comprising exposing said first sorbent cartridge to an enriched stream of air from said closed structure and unloading CO₂ from said first sorbent cartridge to generate an effluent stream of CO₂ into the closed structure.

27. The method of claim 24, wherein (a) further comprises controlling temperature and moisture within said adsorption unit, and using temperature and moisture sensors disposed within said adsorption unit to modulate said inputting of air into said adsorption unit to maintain a predetermined efficiency of CO₂ capture.

28. The method of claim 27, wherein said temperature and moisture sensors measure said temperature and said moisture of an inlet air stream.

29. The method of claim 24, wherein (c) further comprises controlling temperature and moisture within said adsorption unit, and using temperature and moisture sensors disposed within said adsorption unit to modulate said unloading of CO₂ to maintain a predetermined efficiency of CO₂ enrichment.

30. The method of claim 29, wherein said temperature and moisture sensors measure said temperature and said moisture of said effluent stream of CO₂.

31. A device for generating a continuous stream of carbon dioxide (CO₂) in a closed structure, comprising:
an adsorption unit containing an opening for the input of atmospheric air, which comprises oxygen (O₂), nitrogen (N₂) and carbon dioxide (CO₂), wherein said adsorption unit contains at least two sorbent cartridges;
wherein a first sorbent cartridge is positioned to be exposed to an input stream of atmospheric air; and
wherein a second sorbent cartridge positioned to be exposed to a stream of enriched air from the closed structure.

32. The device of claim 31, wherein said sorbent cartridges are positioned on a rotatable structure, said rotatable structure capable of moving each cartridge to be exposed to the input stream of atmospheric air and the input stream of enriched air from the closed structure.
